(19) United States
(12) Patent Application Publication
(10) Pub. No.: US 2005/0245336 A1
(43) Pub. Date: Nov. 3, 2005

(54) Fastening device for a belt type transmission

(76) Inventor: Matthias List, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/112,619

(22) Filed: Apr. 22, 2005

(30) Foreign Application Priority Data
Apr. 29, 2004 (DE) 10 2004 021 014.4

(51) Int. Cl. F16H 59/00; F16H 63/00

(52) U.S. Cl. 474/8; 474/18; 474/28

(57) ABSTRACT

A fastening arrangement on a belt transmission as well as a method for manufacturing it between a shaft (1) and one piston-cylinder unit (5) of a cone pulley pair (2) connected with the shaft (1). The piston-cylinder unit (5) has a first component (6) connected displaceable axially on the shaft (1), but torsion-resistant with the same, which is formed by a cone pulley of the cone pulley pair or by a part operatively connected with a cone pulley displaceable axially on the shaft (1). A second component (7) is connected axially and torsion resistant with the shaft (1), whereby the two components (6, 7) for their part form one pressure chamber (8) of the piston-cylinder unit (5) subject to action by a pressure medium. A simplified and more cost effective fastening arrangement as well as a suitable method for manufacturing it is essentially accomplished by a force and form-locking connection between the second component (7) and the shaft (1).

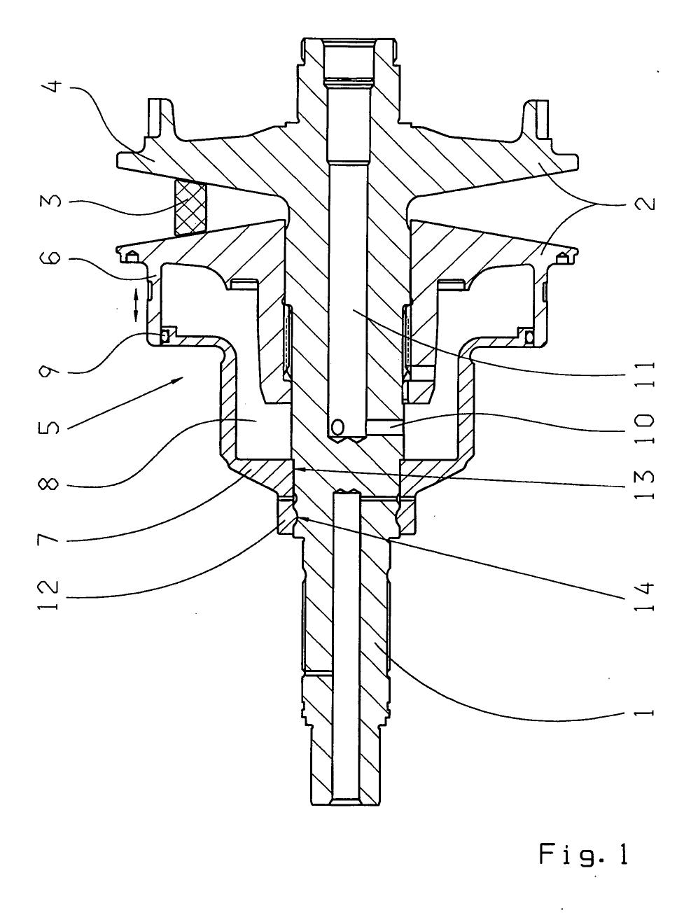

The invention concerns a fastening arrangement on a belt transmission in accordance with the preamble of claim 1 as well as a method for manufacturing a fastening arrangement of this type in accordance with claim 7.

Continuously variable automatic transmissions which have a driving and a driven shaft arranged axle-parallel to each other and respectively bearing on cone pulley pair have been manufactured for a long time. A belt mechanism is passed between the two cone pulleys of each cone pulley pair with which a torque can be transmitted from the input shaft to the output shaft of the transmission.

Each of these cone pulley pairs includes a stationary cone pulley and a cone pulley which is axially displaceable on the shaft, whereby the latter is linked with at least one pressure chamber of a piston-cylinder unit. An axial displacement of the various cone pulleys takes place through an action of pressure with a pressure mechanism as a function of certain operating parameters, such as the torque to be transmitted and the desired gear ratio.

Accordingly, the distance between the two cone pulleys, arranged coaxially in relation to each other, can be altered by a change of pressure in the pressure chamber which again leads to a change in the gear ratio. Moreover, the contact pressure on the belt apparatus can be changed by the noted action of pressure on the axially displaceable cone pulleys, which is decisive for the magnitude of the torque being transmitted.

With known technical solutions, the axially stationary component of the pressure chamber is braced by a force-locking, shaft-hub link using a shaft nut, secured against rotation and sealed. Additionally, a high axial force is required by the system design to secure this component of the piston-cylinder unit against disengagement and a rotation, as well as avoid additional leakage seals.

Because of the unfavorable notch shape of the thread on the shaft to accommodate the shaft nut as well as the high axial forces upon the same, the durability of such shaft is reduced, especially when additional loads are registered upon the shaft by bending and torsion.

Furthermore, often only short clamping lengths can be used for the screw connection due to construction space specifications from which again small changes in length result. Moreover, large axial force losses can disadvantageously arise in connection with setting processes between the components of the piston-cylinder unit. Furthermore, the amplitude of tension increases with the dynamic stressing of the noted screw connection which can, likewise, lead to a reduced durability of the shaft or of the overall connection.

A defined axial force and an extended durability can only be attained from qualitatively very high grade components, especially when there is a very precise tightening method. Additionally, friction values in a very low thread scattering width as well as between the components, resulting in increased manufacturing costs, are necessary.

Against this background, the invention is based upon creating a simplified and, accordingly, more cost effective fastening arrangement on a belt transmission between the shaft and at least one piston-cylinder unit of a cone pulley pair connected with the shaft, especially between the shaft and a component of the piston-cylinder torsion resistant unit linked with the shaft through which the piston-cylinder unit as well as the axially displaceable cone pulley braced on the shaft. Furthermore, a suitable method for manufacturing a fastening arrangement of this type will be introduced.

The solution to this task results from the features of independent claims 1 and 7 while advantageous refinements and further developments of the invention can be inferred, respectively, from the subordinate dependent claims.

This invention is based upon the knowledge that conventional friction-locking, fastening measures for fastening the axial and torsion-resistant component of the piston-cylinder unit on the shaft, specifically fastenings using a shaft nut, for example, always go together with increased mechanical stresses upon the shaft and, in particular, engender notch stresses which can lead to a reduced shelf-life of the shaft or an increased expenditure for materials and processing.

Accordingly, the invention is based on a fastening arrangement on a belt transmission between a shaft and at least one piston-cylinder unit of a cone pulley pair connected with the shaft in which the piston-cylinder unit has a first component that is displaceable axially on the shaft, but linked torsion-resistant with it, which is formed by one cone pulley of the cone pulley pair or by a part operatively linked with a cone pulley axially displaceable on the shaft. Additionally, this fastening arrangement has a second component connected axially and torsion-resistant with the shaft, whereby these two components form at least one pressure chamber of the piston-cylinder unit subject to action by a pressure medium. As a solution to this problem, moreover with this fastening arrangement, it is intended for solving the objective posed that the second component as well as the force is linked form-locking with the shaft.

According to this invention, an increase in the shaft durability can be noted in the combination of a friction lock and form lock, since those axial forces that are brought about exclusively by a friction locking, such as with a screw connection with unfavorable notch shapes, which would represent an additional load for the shaft, are avoided.

In accordance with an especially advantageous refinement of the fastening arrangement of this invention, the friction lock is realized by a press fit of the second component onto the shaft, just as the form lock is brought about by a transformation process of the connection region of the link created by the friction locking from the second component and the shaft, which advantageously takes into account a diminution of the stress on the shaft by specifically avoiding the unfavorable notch forms.

Regarding the transformation process of the invention, circular molding has proven to be especially appropriate for a connection of two work pieces produced on circular molding devices. Here the connection of the second component with the shaft is secure and inseparable, since the latter rests not only upon form-locking, but also on an additional cold welding effect. Furthermore, it is considered to be advantageous that an undisturbed fiber course remains preserved in the material linked with circular molding in contrast with metal cutting processing resulting in an increase in fatigue limit specifically in the bending and vibration stress.

As the invention further provides, the first component is constructed in accordance with the first design as a pressure cylinder which is displaceable on the shaft, but torsion-resistant and the second component is constructed as a piston connected axially and torsion-resistant with the shaft. In accordance with a second design, in contrast, the first component is constructed as a piston which is axially displaceable on the shaft, but torsion-resistant and the second component is constructed as a pressure cylinder connected axially and torsion-resistant with the shaft.

The method for manufacturing a fastening arrangement created by this invention is distinguished in that the second component is, first of all, as a linked friction-lock with the shaft and in that this link is created by the friction lock on the basis of the second component and the shaft for generating an additional form lock in the connecting region, which is subjected to a transformation.

The friction lock here is preferably generated by a press fit of the second component on the shaft.

As regards the form lock of the second component link and the shaft created by the friction lock, this is generated by a circular kneading is the connection region mentioned.

A drawing is appended to the description for clarification of this invention. In the latter, the sole FIGURE depicts an axial section through a shaft 1 of a belt transmission constructed in accordance with the invention, whereby the shaft 1 can be a transmission input shaft as well as a transmission output shaft.

A cone pulley pair 2 is linked with the shaft 1 for accommodation of a belt mechanism 3 in form of a chain, a strap, or a thrust jointed band, whereby a first cone pulley 4, arranged to the right in accordance with the drawing, is connected as a fixed disk and one piece is linked with the shaft 1.

A piston-cylinder unit 5 is arranged coaxially in relation to the fixed disk 4 which has a first component 6 connected axially displaceable on the shaft 1, yet torsion resistant with the same, as well as a second component 7 connected axially and torsion resistant with the shaft 1. The first component 6 is presently formed by a second cone pulley of the cone pulley pair 2 constructed as an axially displaceable cylinder for which purpose the latter has a hollow cylindrical attachment on its side removed from the belt apparatus. The second component 7 is arranged inside this pressure cylinder (component 6) in the form of a piston connected axially and torsion-resistant with the shaft 1.

Both components 6, 7 form a radial rotating pressure chamber 8 subject to action by a pressure medium on the side facing away from the belt mechanism 3 of the axially displaceable cone pulley 6, whereby the surface of the piston (component 7) closely joined on the cylindrical internal contour of the hollow cylindrical attachment of component 6 bears a peripheral seal 9.

Additionally, the pressure chamber 8 is connected with a pressure medium source (not depicted in greater detail), preferably with a hydraulic oil source through a radial borehole 10 as well as an axial borehole 11 inside shaft 1 through which pressure medium can be conducted as needed into the pressure chamber 8.

As a solution of the given task, it is now intended that the second component 7, here then the torsion-resistant piston that cannot be shifted as well as the force are interlocked with the shaft 1.

This document shows that the second component 7 or the piston has a cylindrical fastening bar 12, which is linked with the shaft 1 for securing a high friction lock by a press fit 13 with the shaft 1. This measure guarantees a considerable security against a warping of the second component 7 on the shaft 1. Furthermore a high pressure seal is to be noted in relation to the pressure chamber 8.

As soon as the second component 7 is linked with the shaft 1 by force actuation, the established bond in the connecting area of the fastening bar 12 experiences an interlock such that the connection is transformed in an inherently known as well as a circular molding device (not further illustrated or explained in greater detail).

As represented in the only FIGURE, there is a material penetration from the second component 7 into a prepared circular groove 14 of the shaft 1 which not only forms an internal interlock, but also is based on the highly actuated forces resulting in a particularly advantageous cold welding connection.

Nonetheless, it is also conceivable that a circular groove 14 is dispensed with and the form lock is generated according to a perforating circular molding process in which the material of the second component 7 (piston) penetrates into the material of the shaft 1 (not shown in greater detail) in a largely radial form.

Through the noted interlock, the function for accommodating the axial force is effectively completed. The interlock selected here is such that the shaft 1 and the second component 7 or the piston can be joined with great strength.

Further advantages of the invention in particular also result from cost savings as a consequence of simple manufacture and finishing of the parts to be joined as well as the rapid and cost effective assembly. Moreover, a savings in weight results from a low number of components since a shaft nut or some other mechanical fastening apparatus can be dispensed with.

The above design is based on a first component 6 which can be shifted axially on the shaft 1, but torsion-resistant component 6 that is constructed as a cone pulley with a pressure cylinder, as well as upon a second component 7 in the form of a piston linked axially and torsion-resistant with the shaft 1.

Obviously, the invention is conceived on the basis of constructions in which the component 6 is constructed as a piston and component 7 as a pressure cylinder. Likewise, it is conceivable that component 6 does not directly instruct the second cone pulley, but is operatively connected with it as a pressure cylinder or piston (not represented in greater detail).

### REFERENCE NUMBERS

1 Shaft
2 Cone pulley pair
3 Belt mechanism
4 First cone pulley
5 Piston-cylinder unit
6 First component (second cone pulley/pressure cylinder)
7 Second component (piston)
8 Pressure chamber
9 Peripheral seal
10 Radial bore hole
11 Axial bore hole
12 Fastening bar
13 (Force) Press fit
14 Groove

1-9. (canceled)

10. A fastening arrangement on a belt transmission between a shaft (1) and at least one piston-cylinder unit (5) of a cone pulley pair (2) connected with the shaft (1), the piston-cylinder unit (5) has a first component (6) which is axially displaceable on the shaft (1) but is connected torsion-resistant with the shaft (1), the first component (6) is formed by one of a first cone pulley of the cone pulley pair or a part operatively connected with the first cone pulley axially displaceable on the shaft (1), the first component (6) further has a second component (7) connected axially and torsion-resistant with the shaft (1), the first and second components (6, 7) form at least one pressure chamber (8) of the piston-cylinder unit (5) subject to action by a pressure medium, the second component (7) is force and form interlocked with the shaft (1).

11. The fastening arrangement according to claim 10, wherein the force lock is realized by a press fit (13) of the second component (7) on the shaft (1).

12. The fastening arrangement according to claim 10, wherein the form lock is realized by a transformation process of a connection region of a connection generated by the form lock from the second component (7) and the shaft (1).

13. The fastening arrangement according to claim 12, wherein the form lock is realized by circular kneading.

14. The fastening arrangement according to claim 10, wherein the first component (6) is constructed as a cylinder which is displaceable axially on the shaft (1) but is also torsion resistant and the second component (7) is constructed as a piston connected axially and torsion resistant with the shaft (1).

15. The fastening arrangement according to claim 10, wherein the first component (6) is constructed as a piston axially displaceable on the shaft (1), but torsion resistant, and the second component is axial and torsion resistant with respect to the shaft (1).

16. A method for manufacturing a fastening arrangement on a belt transmission between a shaft (1) and at least one piston-cylinder unit (5) of a cone pulley pair (2) connected with the shaft (1), the piston-cylinder unit (5) has a first component (6) axially displaceable on the shaft (1) but is connected to be torsion-resistant with the shaft (1), the first component (6) is formed by one of a cone pulley of the cone pulley pair (2) or by a part operatively connected with a cone pulley which is axially displaceable on the shaft (1), the first component (6) further has a second component (7) connected axially and torsion resistant with the shaft (1), the first and second components (6, 7) form at least one pressure space (8) of the piston-cylinder unit (5) which can be acted upon with a pressure medium, the second component (7) is connected by friction locking with the shaft (1), and a connection created by the friction lock from the second component (7) and the shaft (1) experiences a transformation for generating an additional form lock in a connection region.

17. The method according to claim 16, wherein the friction lock is generated by a press fit (13) of the second component (7) on the shaft (1).

18. The method according to claim 16, wherein the form lock of the connection from the second component (7) and the shaft (1) created by the friction lock is generated in a connection area mentioned by a circular molding.
